(19) United States
(12) Patent Application Publication
(10) Pub. No.: US 2015/0262758 A1
(43) Pub. Date: Sep. 17, 2015

(54) MEMS DEVICE

(71) Applicant: KABUSHIKI KAISHA TOSHIBA, Tokyo (JP)

(72) Inventor: Hiroaki YAMAZAKI, Yokohama (JP)

(73) Assignee: KABUSHIKI KAISHA TOSHIBA, Tokyo (JP)

(21) Appl. No.: 14/481,846

(22) Filed: Sep. 9, 2014

(30) Foreign Application Priority Data
Mar. 13, 2014 (JP) 2014-049678

(51) Int. Cl. H01G 5/16

(52) U.S. Cl. CPC H01G 5/16

(57) ABSTRACT

According to one embodiment, a MEMS device includes a first variable capacitor including a first lower electrode fixed to a substrate, and a movable first upper electrode provided above the first lower electrode, a second variable capacitor including a second lower electrode fixed to the substrate, and a movable second upper electrode provided above the second lower electrode, and a connection part configured to electrically and mechanically connect the first upper electrode and the second upper electrode to each other.

### CROSS-REFERENCE TO RELATED APPLICATIONS

This application is based upon and claims the benefit of priority from Japanese Patent Application No. 2014-049678, filed Mar. 13, 2014, the entire contents of which are incorporated herein by reference.

### FIELD

Embodiments described herein relate generally to a MEMS (micro-electromechanical systems) device.

### BACKGROUND

A variable capacitor using the MEMS technique is proposed. However, when an electrode area of a MEMS element is changed, the mechanical characteristics other than the capacitance value are also changed. For this reason, an increase in characteristic variation, increase in design period, and the like occur. Accordingly, a MEMS device capable of realizing variable capacitance having a large capacitance value without changing the electrode area of each MEMS element is desired.

### BRIEF DESCRIPTION OF THE DRAWINGS

FIG. 1 is a plan view schematically showing the basic planar configuration of a MEMS device according to an embodiment.

FIG. 2 is a cross-sectional view schematically showing the basic configuration of the MEMS device according to the embodiment.

FIG. 3 is a plan view schematically showing the basic planar configuration of a MEMS device according to a modification example of the embodiment.

FIG. 4 is an electric circuit diagram showing a first configuration example of a case where the variable capacitors of the embodiment are applied to a capacitor bank.

FIG. 5 is an electric circuit diagram showing a second configuration example of a case where the variable capacitors of the embodiment are applied to a capacitor bank.

FIG. 6 is a plan view schematically showing a first configuration example of a connection part.

FIG. 7 is a plan view schematically showing a second configuration example of the connection part.

FIG. 8 is a plan view schematically showing a third configuration example of the connection part.

FIG. 9 is a plan view schematically showing a fourth configuration example of the connection part.

### DETAILED DESCRIPTION

In general, according to one embodiment, a MEMS device includes: a first variable capacitor including a first lower electrode fixed to a substrate, and a movable first upper electrode provided above the first lower electrode; a second variable capacitor including a second lower electrode fixed to the substrate, and a movable second upper electrode provided above the second lower electrode; and a connection part configured to electrically and mechanically connect the first upper electrode and the second upper electrode to each other.

Hereinafter, an embodiment will be described with reference to the drawings.

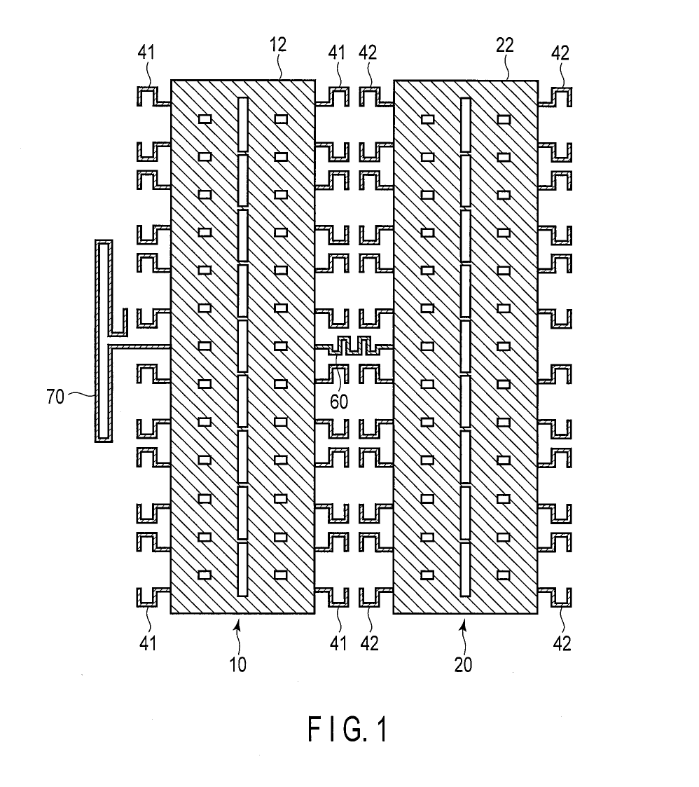

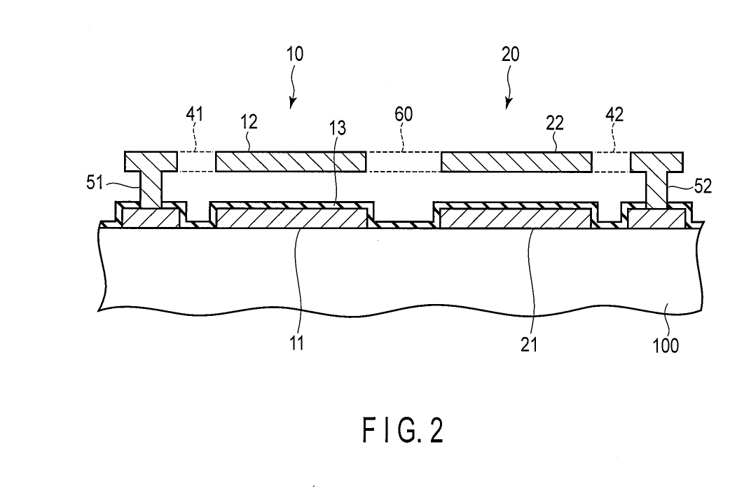

FIG. 1 is a plan view (planar pattern view) schematically showing the basic planar configuration of a MEMS device according to the embodiment. FIG. 2 is a cross-sectional view schematically showing the basic configuration of the MEMS device according to the embodiment. The MEMS device according to the embodiment is used for a variable capacitor.

As shown in FIG. 1, and FIG. 2, a first variable capacitor 10 and second variable capacitor 20 are formed on a substrate 100. In the substrate 100, a semiconductor substrate, circuit (for example, a circuit configured to control and drive a variable capacitor) including transistors, interconnects, and the like, interlayer insulating film, and the like are included.

The first variable capacitor 10 includes a first lower electrode 11 fixed to the substrate 100, and movable first upper electrode 12 provided above the first lower electrode 11. The second variable capacitor 20 includes a second lower electrode 21 fixed to the substrate 100, and movable second upper electrode 22 provided above the second lower electrode 21. On the first lower electrode 11, and second lower electrode 21, a dielectric film 13 is provided.

In the first variable capacitor 10, electrostatic force acts between the first lower electrode 11, and first upper electrode 12 when an appropriate voltage is applied between the first lower electrode 11, and first upper electrode 12, and the first upper electrode 12 is displaced. As a result, the distance between the first lower electrode 11, and first upper electrode 12 is changed, and the capacitance of the first variable capacitor 10 is changed. The first variable capacitor 10 can take a state (pull-in state) where the first upper electrode 12 is in contact with the dielectric film 13, and state (pull-out state) where the first upper electrode 12 is separate from the dielectric film 13. Accordingly, the first variable capacitor 10 functions as a binary variable capacitor. It should be noted that the above description also applies to the second variable capacitor 20.

At least one insulating spring 41 is connected to the first upper electrode 12. Likewise, at least one insulating spring 42 is connected to the second upper electrode 22. These insulating springs 41, and 42 are formed of a material having brittleness. For example, silicon nitride (SiN) is used for the material having brittleness. The insulating springs 41, and 42 are each supported by anchors 51, and 52.

The first upper electrode 12, and the second upper electrode 22 are electrically and mechanically connected to each other by a first connection part 60. The first connection part 60 is constituted of a spring formed of an electric conductor, and includes at least one bending part. Further, it is desirable that the first connection part (spring) 60 be simultaneously formed by a process identical to the process for forming the first and second upper electrodes 12 and 22, and be formed of a material identical to the material for the first and second upper electrodes 12 and 22. More specifically, it is desirable that the spring 60 be formed of a metal such as aluminum or the like. By providing the first connection part (spring) 60, the first upper electrode 12 of the first variable capacitor 10, and the second upper electrode 22 of the second variable capacitor 20 are electrically connected to each other. As a result, it is possible to realize a capacitance value twice as large as a value of a case where the first variable capacitor 10 is singly used by means of the first variable capacitor 10, and second variable capacitor 20 which are connected in parallel with each other. In this case, design is carried out in such a manner that the first variable capacitor 10, and the second variable capacitor 20 have the same shape, and the spring constant of the first connection part 60 is sufficiently smaller than those of the insulating springs 41 and 42. Thereby, it is possible for the capacitors connected in parallel with each other by the first connection part 60 to realize drive characteristics identical to the case where the first variable capacitor 10 is singly used.

It is desirable that the first connection part 60 be configured in such a manner that the first upper electrode 12, and the second upper electrode 22 are simultaneously displaced by the first connection part 60. The first upper electrode 12, and the second upper electrode 22 are simultaneously displaced, whereby it is possible to treat the first variable capacitor 10, and second variable capacitor 20 as one variable capacitor. In order to simultaneously displace the first upper electrode 12, and second upper electrode 22, it is desirable that the configuration be made in such a manner that the spring constant of the first connection part 60 is comparatively high. This point will be described later. In this case too, it is desirable that design be carried out in such a manner that the spring constant of the first connection part 60 is sufficiently smaller than those of the insulating springs 41 and 42.

A bias line 70 is connected to the first upper electrode 12. It is possible, by means of this bias line 70, to apply a desired voltage to the first upper electrode 12.

As described above, in this embodiment, the first upper electrode 12 of the first variable capacitor 10, and the second upper electrode 22 of the second variable capacitor 20 are electrically connected to each other by the first connection part 60, and hence it is possible to realize large capacitance by the first and second variable capacitors 10 and 20. Further, in this embodiment, by simultaneously displacing the first upper electrode 12, and second upper electrode 22 by means of the first connection part 60, it is possible to treat the first and second variable capacitors 10 and 20 as one variable capacitor, and obtain a variable capacitor having large capacitance.

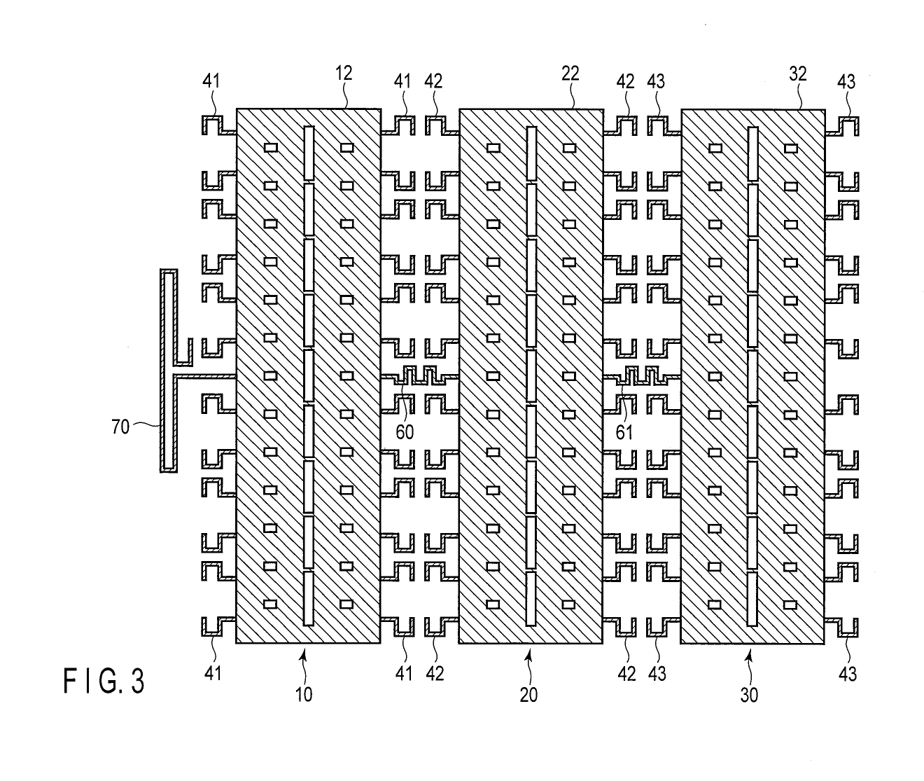

FIG. 3 is a plan view (planar pattern view) schematically showing the basic planar configuration of a MEMS device according to a modification example of the embodiment. It should be noted that the basis configuration is identical to the configuration of the embodiment shown in FIG. 1 and FIG. 2, and hence descriptions of the matters mentioned in the embodiment shown in FIG. 1 and FIG. 2 are omitted.

In this modification example, a third variable capacitor 30 is provided in addition to the first variable capacitor 10, and second variable capacitor 20.

The basic configuration of the third variable capacitor 30 is identical to the configuration of each of the first variable capacitor 10, and second variable capacitor 20. That is, the third variable capacitor 30 includes a third lower electrode (not shown) fixed to the substrate, and movable third upper electrode 32 provided above the third lower electrode. On the third lower electrode, a dielectric film 13 shown in FIG. 2 is provided. A basic operation of the third variable capacitor 30 is also identical to those of the first variable capacitor 10, and second variable capacitor 20.

At least one insulating spring 43 is connected to the third upper electrode 32. The configuration of the insulating spring 43, material for the insulating spring 43, and so on are also identical to the insulating springs 41 and 42 described in the above embodiment.

The second upper electrode 22, and the third upper electrode 32 are electrically and mechanically connected to each other by a second connection part 61. The second connection part 61 is also identical to the first connection part 60 described in the above embodiment.

In this modification example, the first upper electrode 12 of the first variable capacitor 10, and the second upper electrode 22 of the second variable capacitor 20 are electrically connected to each other by the first connection part 60, and the second upper electrode 22 of the second variable capacitor 20, and the third upper electrode 32 of the third variable capacitor 30 are electrically connected to each other by the second connection part 61, and hence it is possible to realize large capacitance by the first, second, and third variable capacitors 10, 20, and 30. Further, by simultaneously displacing the first, second, and third upper electrodes 12, 22, and 32 by means of the connection parts, it is possible to treat the first, second, and third variable capacitors 10, 20, and 30 as one variable capacitor, and obtain a variable capacitor having large capacitance.

It should be noted that in the above-mentioned modification example, although the three variable capacitors, i.e., the first, second, and third variable capacitors 10, 20, and 30 are connected in parallel with each other by the first, and second connection parts 60, and 61, more variable capacitors may be connected in parallel with each other by more connection parts.

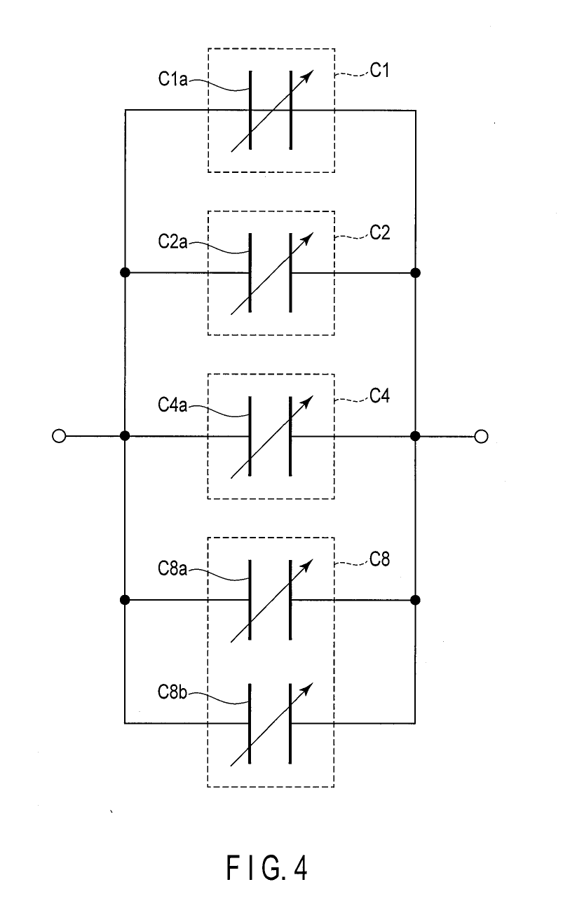

FIG. 4 is an electric circuit diagram showing a first configuration example of a case where the variable capacitors of the embodiment are applied to a capacitor bank.

The capacitor bank shown in FIG. 4 is constituted of a variable capacitor part C1, variable capacitor part C2, variable capacitor part C4, and variable capacitor part C8. The variable capacitor parts C1, C2, and C4 are constituted of single variable capacitors C1a, C2a, and C4a, respectively. The variable capacitor part C8 is constituted of variable capacitors C8a, and C8b. The variable capacitor C8a, and the variable capacitor C8b respectively correspond to the first variable capacitor 10, and second variable capacitor 20 shown in FIG. 1, and FIG. 2. It is assumed that a range of variation in capacitance of the variable capacitor part C1 is ΔC1 range of variation in capacitance of the variable capacitor part C2 is ΔC2, range of variation in capacitance of the variable capacitor part C4 is ΔC4, and range of variation in capacitance of the variable capacitor part C8 is ΔC8. In this case, the following relationships are established.

ΔC2=2×ΔC1

ΔC4=4×ΔC1

ΔC8=8×ΔC1

Each of the variable capacitor C8a, and the variable capacitor C8b has a shape and area identical to the variable capacitor C4a. Accordingly, a range of variation in capacitance of each of the variable capacitor C8a, and variable capacitor C8b is ΔC4. Further, the upper electrode of the variable capacitor C8a, and the upper electrode of the variable capacitor C8b each have the same shape and the same area. Further, the upper electrode of the variable capacitor C8a, and the upper electrode of the variable capacitor C8b are configured in such a manner that they are simultaneously displaced.

Each of the variable capacitor part C1, variable capacitor part C2, variable capacitor part C4, and variable capacitor part C8 (the variable capacitor C8a, and variable capacitor C8b) constitutes a binary variable capacitor. Accordingly, it is possible to set 16 combinations of capacitance values to the capacitor bank shown in FIG. 4.

Here, when it is assumed that the variable capacitor C8a, and the variable capacitor C8b each constituting the variable capacitor part C8 do not simultaneously shift to the pull-in state, the following inconvenience occurs. Here, a case where transition is made from a situation in which the variable capacitors C1a, C2a, and C4a are in the pull-in state, and the variable capacitors C8a, and C8b are in the pull-out state to a situation in which the variable capacitors C1a, C2a, and C4a are in the pull-out state, and the variable capacitors C8a, and C8b are in the pull-in state is considered. In this case, if one of the variable capacitors C8a, and the variable capacitor C8b does not shift to the pull-in state, the capacitance value becomes smaller than the regular capacitance value (capacitance value of a case where both the variable capacitor C8a, and the variable capacitor C8b are in the pull-in state).

In this configuration example, the upper electrode of the variable capacitor C8a, and the upper electrode of the variable capacitor C8b are simultaneously displaced. That is, the variable capacitor C8a, and the variable capacitor C8b simultaneously shift to the pull-in state. Accordingly, in this embodiment, it is possible to avoid the above-mentioned problem.

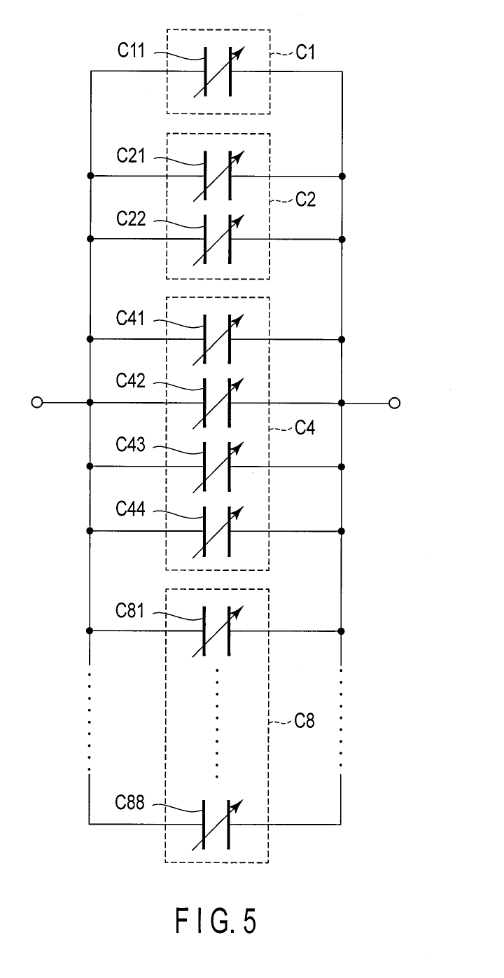

FIG. 5 is an electric circuit diagram showing a second configuration example of a case where the variable capacitors of the embodiment are applied to a capacitor bank.

The capacitor bank shown in FIG. 5 is constituted of a variable capacitor part C1, variable capacitor part C2, variable capacitor part C4, and variable capacitor part C8. The variable capacitor part C1 is constituted of one variable capacitor C11. The variable capacitor part C2 is constituted of two variable capacitors C21 and C22. The variable capacitor part C4 is constituted of four variable capacitors C41, C42, C43, and C44. The variable capacitor part C8 is constituted of eight variable capacitors C81 to C88.

The variable capacitors C21 and C22 are connected to each other by a connection part 60 shown in FIG. 1 and FIG. 2, and simultaneously shift to the pull-in state. The variable capacitors C41, C42, C43, and C44 are also connected to each other in a similar manner by connection parts 60 shown in FIG. 1 and FIG. 2. That is, the variable capacitors C41 and C42 are connected to each other by one connection part, the variable capacitors C42 and C43 are connected to each other by another connection part, and the variable capacitors C43 and C44 are connected to each other by still another connection part. Accordingly, the variable capacitors C41, C42, C43, and C44 simultaneously shift to the pull-in state. Regarding the variable capacitors C81 to C88, adjacent capacitors are connected to each other by a connection part shown in FIG. 1 and FIG. 2 in a similar manner. Accordingly, all the variable capacitors C81 to C88 simultaneously shift to the pull-in state.

It is assumed that a range of variation in capacitance of the variable capacitor part C1 is ΔC1, range of variation in capacitance of the variable capacitor part C2 is ΔC2, range of variation in capacitance of the variable capacitor part C4 is ΔC4, and range of variation in capacitance of the variable capacitor part C8 is ΔC8. In this case, the following relationships are established.

ΔC2=2×C1

ΔC4=4×C1

ΔC8=8×ΔC1

Further, each of all the variable capacitors (C11, C21, C22, C41, C42, C43, C44, and C81 to C88) has an identical shape and identical area.

Each of the variable capacitor part C1, variable capacitor part C2, variable capacitor part C4, and variable capacitor part C8 constitutes a binary variable capacitor. Accordingly, it is possible to set 16 combinations of capacitance values to the capacitor bank shown in FIG. 5.

In this configuration example, the capacitors C21 and C22 constituting the variable capacitor part C2 simultaneously shift to the pull-in state. Further, the capacitors C41, C42, C43, and C44 constituting the variable capacitor part C4 simultaneously shift to the pull-in state. Further, the capacitors C81 to C88 constituting the variable capacitor part C8 simultaneously shift to the pull-in state. Accordingly, in this configuration example too, it is possible to obtain an advantage identical to the first configuration example. Furthermore, in this configuration example, each of all the variable capacitors (C11, C21, C22, C41, C42, C43, C44, and C81 to C88) has an identical shape and identical area, and hence it is possible to simplify the design and manufacturing process.

Next, various configuration examples of the first connection part 60 will be described below.

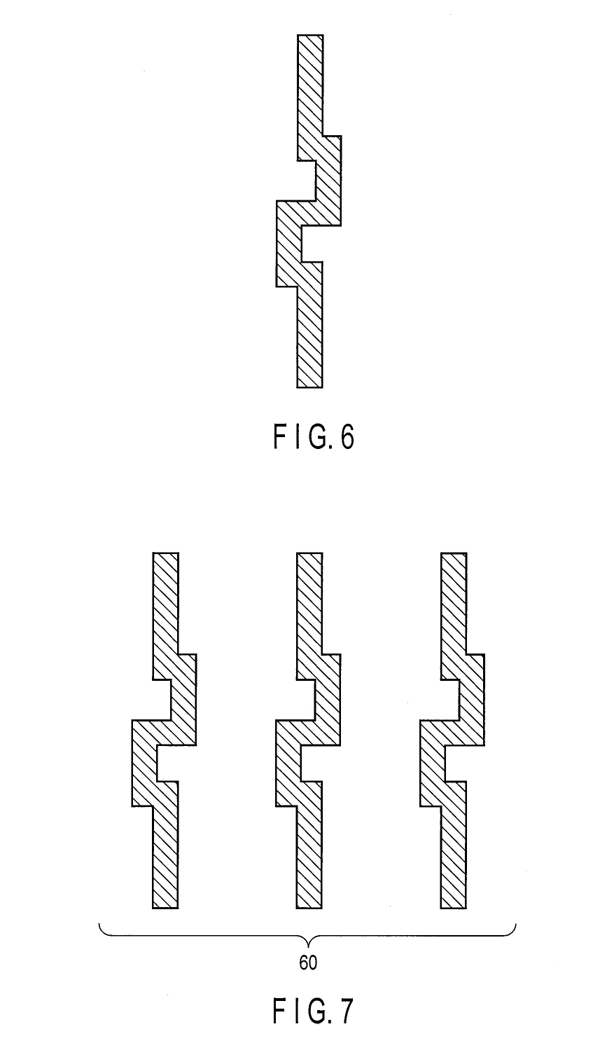

FIG. 6 is a plan view (planar pattern view) schematically showing a first configuration example of the first connection part 60. In this configuration example, the first connection part 60 is constituted of a single spring, and the spring includes at least one bending part. As described above, by providing the spring with a bending part, it is possible to prevent buckling from occurring.

FIG. 7 is a plan view (planar pattern view) schematically showing a second configuration example of the first connection part 60. In this configuration example, the first connection part 60 is constituted of a plurality of springs, and each of the springs includes at least one bending part. That is, in this configuration example in comparison with the first configuration example of FIG. 6, additional springs are included in the first connection part 60. The additional springs may be formed of an electric conductor or may be formed of an insulator. Accordingly, it is sufficient if at least one spring included in the first connection part 60 is formed of an electric conductor. As described above, in this configuration example too, it is possible to prevent buckling from occurring by providing each spring with a bending part. Further, the first connection part 60 is constituted of a plurality of springs, whereby it is possible to constitute a hard connection part. By constituting the connection part having high rigidity, it becomes easy, when the capacitance value is to be changed, to simultaneously displace the plurality of variable capacitors.

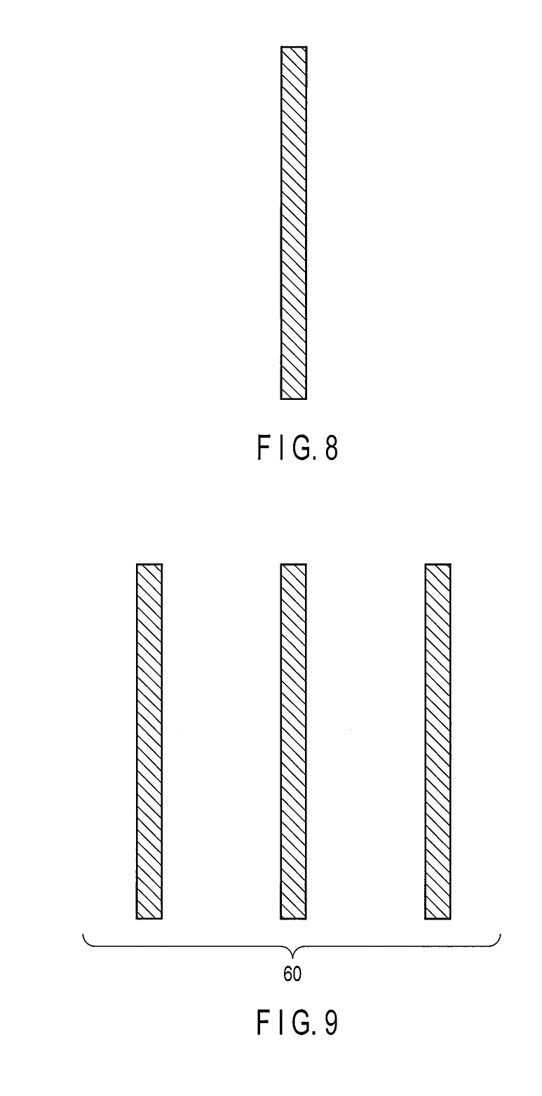

FIG. 8 is a plan view (planar pattern view) schematically showing a third configuration example of the first connection part 60. In this configuration example, the first connection part 60 is constituted of a single spring, and the spring has a linear shape. By making the spring linear as described above, it is possible to constitute a hard connection part. Thereby, it becomes easy, when the capacitance value is to be changed, to simultaneously displace the plurality of variable capacitors.

FIG. 9 is a plan view (planar pattern view) schematically showing a fourth configuration example of the first connection part 60. In this configuration example, the first connection part 60 is constituted of a plurality of springs, and each of the springs has a linear shape. That is, in this configuration example in comparison with the third example of FIG. 8, additional springs are included in the first connection part 60. The additional springs may be formed of an electric conductor or may be formed of an insulator. Accordingly, it is sufficient if at least one spring included in the first connection part 60 is formed of an electric conductor. As described above, by providing a plurality of linear springs, it is possible to constitute a harder connection part. Thereby, it becomes easy, when the capacitance value is to be changed, to simultaneously displace the plurality of variable capacitors.

Further, in order to constitute a hard connection part, it is desirable that a width of each spring included in the connection part be made larger.

It should be noted that in the aforementioned embodiment, although capacitors each having an identical shape, and identical area are connected to each other by a connection part, the capacitors to be connected to each other by the connection part may each have different shapes, and different areas.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A MEMS device comprising:
a first variable capacitor including a first lower electrode fixed to a substrate, and a movable first upper electrode provided above the first lower electrode;
a second variable capacitor including a second lower electrode fixed to the substrate, and a movable second upper electrode provided above the second lower electrode; and
a connection part configured to electrically and mechanically connect the first upper electrode and the second upper electrode to each other.

2. The device of claim 1, wherein
the connection part is configured to simultaneously displace the first upper electrode and the second upper electrode.

3. The device of claim 1, wherein
the connection part includes a spring formed of an electric conductor.

4. The device of claim 3, wherein
the spring includes at least one bending part.

5. The device of claim 3, wherein
the spring is linear.

6. The device of claim 3, wherein
the connection part further includes an additional spring.

7. The device of claim 6, wherein
the additional spring is formed of an electric conductor.

8. The device of claim 6, wherein
the additional spring is formed of an insulator.

9. The device of claim 6, wherein
the additional spring includes at least one bending part.

10. The device of claim 2, wherein
the spring is formed of a metal.

11. The device of claim 3, wherein
the spring is formed of a material identical to a material for the first upper electrode and the second upper electrode.

12. The device of claim 3, wherein
the spring is formed of a brittle material.

13. The device of claim 1, further comprising at least one insulating spring connected to the first upper electrode.

14. The device of claim 13, wherein
the at least one insulating spring is formed of a brittle material.

15. The device of claim 1, wherein
an area of the first upper electrode and an area of the second upper electrode are identical to each other.

16. The device of claim 1, further comprising:
a third variable capacitor including a third lower electrode fixed to the substrate, and a movable third upper electrode provided above the third lower electrode; and
a second connection part configured to electrically and mechanically connect the second upper electrode and the third upper electrode to each other, and including a second spring formed of an electric conductor.

17. The device of claim 16, wherein
the second connection part is configured to simultaneously displace the second upper electrode and the third upper electrode.
